(19) United States
(12) Patent Application Publication
(10) Pub. No.: US 2006/0268829 A1
(43) Pub. Date: Nov. 30, 2006

(54) Approach for securely auto-deploying IP telephony devices

(76) Inventor: Plamen Nedeltchev, Santa Clara, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/129,098

(22) Filed: May 13, 2005

(51) Int. Cl. H04L 12/66

(52) U.S. Cl. 370/352

(57) ABSTRACT

An approach is provided for securely and remotely deploying and configuring IP telephony devices. A user applies for IP telephony service. The user is approved and a directory number is assigned to the user's IP telephony device. The IP telephony device is connected to a router and powered up. The router detects IP traffic from the IP telephony device and obtains data that uniquely identifies the IP telephony device, such as a Media Access Control (MAC) address. The IP telephony device registers with a certificate authority and receives a digital certificate. The router generates and sends a configuration request to a configuration agent over a secure communications link. The configuration request is verified, a configuration manager is auto-configured if the request is granted and configuration data is provided to the IP telephony device over the secure communications link and implemented by the IP telephony device.

### FIELD OF THE INVENTION

This invention relates generally to telephony, and more specifically, to an approach for securely auto-deploying IP telephony devices.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

One of the issues with deploying IP telephony devices is that although physically installing IP telephony devices may be relatively straightforward, the installed IP telephony devices must then be configured and customized. The configuration manager and other head end equipment configuration typically require a high level of user knowledge and involvement. For example, configuring an IP telephone with secure network connections, such as Virtual Private Networks (VPNs), can be tedious and difficult or impossible to troubleshoot for end users who are not experienced in such tasks. In corporate environments, it is not uncommon for deployment specialists to manually configure IP telephony devices before they are installed at their destinations. Although this reduces the burden on end users, it does not address the administrative burden and associated configuration and operational cost, which in general increases the total cost of ownership (TCO). In some situations, a large number of IP telephony devices need to be deployed as quickly and inexpensively as possible. This is difficult to do using conventional approaches because of the human resources that are required to manually configure a large number of IP telephony devices and the head end equipment. Mistakes can also be made during the manual configuration process, which can require reconfiguring some 1P telephony devices. IP telephony devices beyond the corporate premises (remotely) create additional security concerns, typically associated with “spoofing” the MAC address of the IP phone and by passing the corporate authentication and authorization policies. Furthermore, corporate policies that drive the configuration of network devices are often not static and can change unexpectedly. Thus, last minute changes in corporate policies can also require reconfiguring IP telephony devices that have already been configured according to a prior corporate policy, which adds to the cost and can cause delays in deployment.

Based on the foregoing, there is a need for an approach for deploying IP telephony devices that does not suffer from limitations of prior approaches.

### BRIEF DESCRIPTION OF THE DRAWINGS

In the figures of the accompanying drawings like reference numerals refer to similar elements.

FIG. 1 is a block diagram that depicts an arrangement for securely deploying a telephony device, according to an embodiment of the invention.

FIG. 2 is a flow diagram that depicts an approach for securely deploying an IP telephony device, according to an embodiment of the invention.

FIG. 3 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:

I. OVERVIEW

II. ARCHITECTURE

III. SECURE DEPLOYMENT OF IP TELEPHONY DEVICES

IV. SECURITY CONSIDERATIONS

V. IMPLEMENTATION MECHANISMS

I. Overview

An approach is provided for securely and remotely deploying and configuring IP telephony devices. A user applies for IP telephony service. The user is approved and a directory number is assigned to the user's IP telephony device. The IP telephony device is connected to a router and powered up. The router detects IP traffic from the IP telephony device and obtains data that uniquely identifies the IP telephony device, such as a Media Access Control (MAC) address. The IP telephony device registers with a certificate authority and receives a digital certificate. The router generates and sends a configuration request to a configuration agent over a secure communications link. The configuration request is verified, a configuration manager is auto-configured if the request is granted and configuration data is provided to the IP telephony device over the secure communications link and implemented by the IP telephony device. The approach provides an automatic remote and secure IP telephony device deployment and head end configuration solution that is user friendly.

II. Architecture

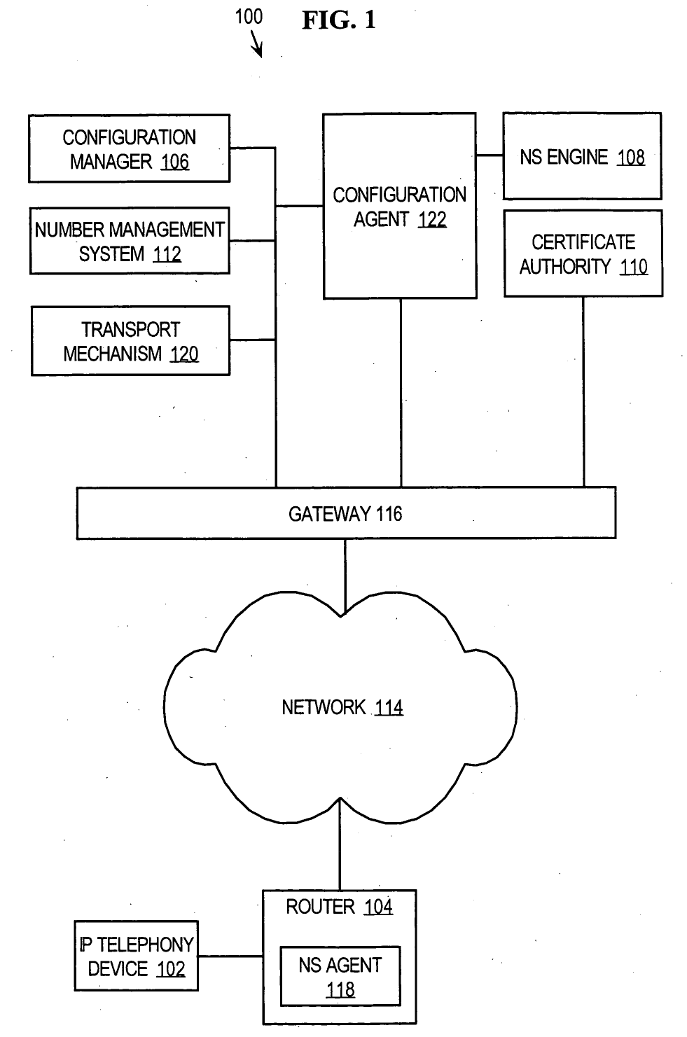

FIG. 1 is a block diagram that depicts an arrangement 100 for securely deploying an IP telephony device, according to an embodiment of the invention. Arrangement 100 includes an IP telephony device 102, a router 104, a configuration manager 106, a network services (NS) engine 108, a certificate authority 110, a number management system 112, a transport mechanism 120 and a configuration agent 122. These elements are communicatively coupled via a network 114. Network 114 may be implemented by any mechanism or medium that provides for the exchange of data between the various elements depicted in FIG. 1. Examples of network 114 include, without limitation, a network such as a Local Area Network (LAN), Wide Area Network (WAN), Ethernet or the Internet, or one or more terrestrial, satellite or wireless links. Other communications links and methods may be provided between the elements depicted in FIG. 1, depending upon a particular implementation. Configuration manager 106, NS engine 108, certificate authority 110, number management system 112, transport mechanism 120 and configuration agent 122 may be communicatively coupled to network 114 via a gateway 116, for security purposes, for example in corporate enterprise applications. For purposes of explanation, embodiments of the invention are described hereinafter in the context of deploying a single IP telephony device 102. The approach is not limited to this context however, and is applicable to deploying any type and number of network devices. Furthermore, although embodiments of the invention are described herein in the context of IP telephony device 102 being connected to network 114 via router 104, the invention is not limited to this context and other connectivity mechanisms may be used.

IP telephony device 102 may be any type of device or mechanism that is configured to provide telephone service using voice over IP. Examples of IP telephony device 102 include, without limitation, IP telephones, Personal Digital Assistants (PDAs), personal computers, handheld devices, wireless or mobile devices of any type and so called “soft phones”. Router 104 is configured with a network services (NS) agent 118, for example, a Cisco NS agent (CNS).

Configuration manager 106 may be implemented by any type of configuration manager mechanism that is capable of managing configuration data for IP telephony devices. One example implementation of configuration manager 106 is a Cisco Call Manager. Configuration manager 106 is configured with a transport mechanism 120 and a configuration agent 122. Transport mechanism 120 provides configuration information to IP telephony device 102, as described in more detail hereinafter. Transport mechanism 120 may be implemented using a variety of mechanisms and the invention is not limited to transport mechanism being implemented using a particular mechanism. Examples of transport mechanism 120 include, without limitation, a Trivial File Transfer Protocol (TFTP) server, a File Transfer Protocol (FTP) server and a HyperText Transfer Protocol (HTTP) server. An example of configuration agent 122 is a Java agent hosted in an enterprise system. Certificate authority 110 is any mechanism that manages certificates. Number management system 112 may be implemented by any system for managing telephone numbers.

Although IP telephony device 102, router 104, configuration manager 106, network services (NS) engine 108, certificate authority 110, number management system 112, transport mechanism 120 and configuration agent 122 are depicted in FIG. 1 as separate components or entities, the functionality of these elements may be combined in one or more components, in any combination, depending upon a particular implementation. In addition, any of the elements of FIG. 1 may be disposed within network 114. The operation of the various components depicted in FIG. 1 is described in more detail hereinafter.

III. Secure Deployment of IP Telephony Devices

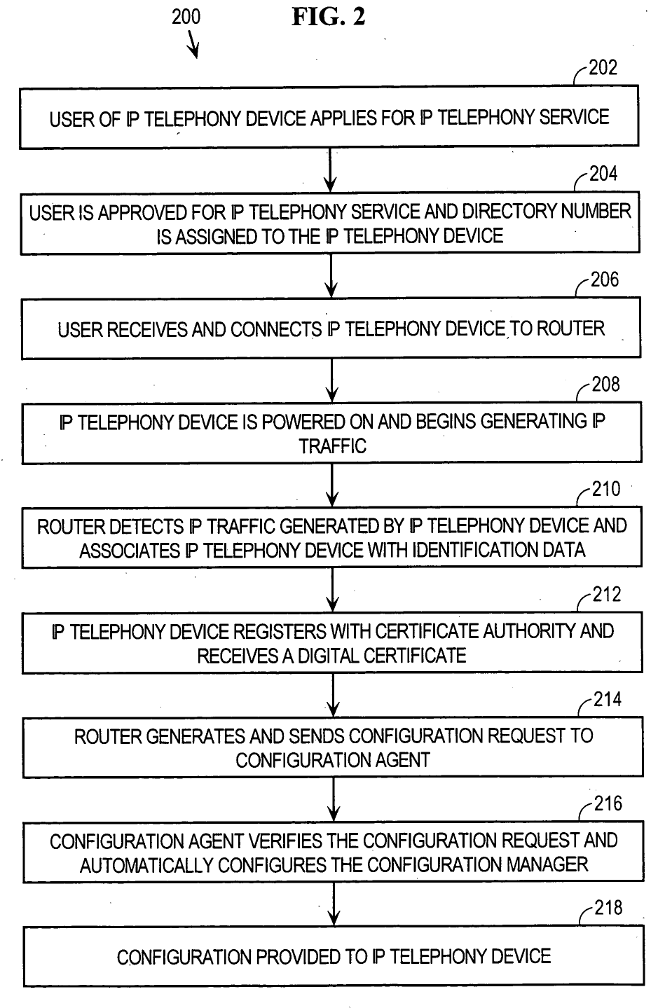

The approach for securely deploying IP telephony devices is now described with reference to a flow diagram 200 depicted in FIG. 2 in the context of deploying IP telephony device 102. It is presumed before the process beings that router 104 is communicatively coupled to network 114 and that secure communications are available between router 104 and other components, such as configuration manager 106, NS engine 108 and certificate authority 110. Secure communications may be made available using a wide variety of techniques, depending upon a particular implementation, and the invention is not limited to any particular secure communications technique. For example, a VPN or HTTPS may be used to provide secure communications between router 104 and other elements depicted in FIG. 1.

In step 202, a user of IP telephony device 102 applies for IP telephony service according to an entitlement process that may vary, for example, based upon particular corporate policies.

In step 204, the user is approved for telephony service and a directory number is assigned to IP telephony device 102. Directory numbers may be managed using a variety of mechanisms, such as number management system 112.

In step 206, the user receives and connects IP telephony device 102 to router 104.

In step 208, IP telephony device 102 is powered on and begins generating IP traffic. For example, when powered on, IP telephony device 102 may send a request for configuration information to router 104 or attempt to read a user profile from router 104.

In step 210, router 104 detects the IP traffic generated by router 104 and obtains identification data that uniquely identifies IP telephony device 102. Router 104 may be configured with a monitoring mechanism capable of monitoring communications received from IP telephony device 102. For example, router 104 may be configured with an operating system that includes functionality to detect IP traffic generated by IP telephony device 102. One example operating system is Cisco System's Internet Operating System (IOS) that may be configured to detect IP traffic generated by IP telephony device 102 and notify NS agent 118.

The identification data may be any type of data that uniquely identifies IP telephony device 102. Two examples of identification data are the Media Access Control (MAC) address and the Data Link Control (DLC) address of IP telephony device 102. Router 104 may obtain the identification data for IP telephony device 102 by performing a lookup based upon the IP address of IP telephony device 102. Alternatively, router 104 may performing a lookup based upon the socket associated with IP telephony device 102, i.e., the IP address and port number pair for IP telephony device 102. The lookup data, i.e., the IP address/identification data pairings or socket/identification data pairings, may be maintained by router 104 or obtained from another location, for example, from a-network management database. The lookup data may be controlled or locked for specified times, including indefinitely, to provide additional security. Router 104 may also be configured to provide a notification when the lookup data is changed. For example, NS agent 118 may be configured to provide a notification to NS engine 108 whenever an IP address/identification data or socket/identification data pairing is changed, to allow the changes to be traced.

In step 212, IP telephony device 102 registers with certificate authority 110 and is issued a digital certificate to be used in secure communications and to authenticate IP telephony device 102.

In step 214, router 104 generates a configuration request and sends the configuration request to configuration agent 122. The configuration request generated by router 104 contains sufficient information to allow configuration manager 106 to configure IP telephony device 102. According to one embodiment of the invention, the configuration request includes the IP address of IP telephony device 102 and the identification data that uniquely identifies IP telephony device 102, such as the MAC address of IP telephony device 102.

In step 216, configuration agent 122 verifies the configuration request received from router 104. To perform the verification, configuration agent 122 determines whether IP telephony service has been approved for an IP telephone device associated with the identification data included in the configuration request. For example, configuration agent 122 may verify the configuration request by determining whether a directory number has been established in number management system 112 for an IP telephony device having the MAC address contained in the configuration request. If so, then the configuration request is valid and configuration agent 122 causes IP telephony device 102 to be configured in configuration manager 106. If IP telephony device 102 is already configured in configuration manager 106, then the request is ignored. If the request is invalid, an error message may be generated to indicate that the configuration request cannot be granted.

In step 218, assuming the configuration request has been successfully performed, then transport mechanism 120 provides configuration data to IP telephony device 102 and the configuration data is implemented on IP telephony device 102. For example, in the context of transport mechanism 120 being implemented as a TFTP server, a TFTP session is conducted between the TFTP server and IP telephony device 102.

There are numerous variations to the above approach that may be used, depending upon a particular implementation. Not all of the steps depicted in FIG. 2 necessarily need to be performed, or in the order depicted in FIG. 2. Furthermore, additional steps may be used. According to one embodiment of the invention, a configuration request is initiated by NS agent 118 causing a connection event. NS engine 108 detects and processes the event, which includes publishing the event on a TIBCO bus. Configuration agent 122 intercepts the published event and causes a configuration request to be generated and processed by configuration manager 106. In this situation, configuration agent 122 causes configuration manager 106 to be configured based upon information from NS engine 108 and number management system 112. Configuration agent 122 may also cause a session to be initiated between transport mechanism 120 and IP telephony device 102. Many other variations and modifications of this approach may be used, and this is only one example.

IV. Security Considerations

Security is often a concern when deploying network devices, including IP telephony devices, because there is a risk that a third party may attempt to “spoof” an authorized IP telephony device to gain access to IP telephony services. The approach described herein provides a secure approach for deploying IP telephony devices in several respects. Communications between IP telephony device 102 and other devices are implemented using a secure connection, to make it more difficult for a third party to intercept, for example, a configuration request containing the MAC address of IP telephony device 102. Also, as described herein, the lookup data, i.e., the IP address/identification data pairings or socket/identification data pairings, may be securely maintained and/or locked for specified times to provide additional security. Changes to the lookup data may also be traced by generating a notification message when changes to the lookup data are made. To provide additional security, IP telephony device 102 may be configured with a “certificate of local significance”. The certificate of local significance is a non-exportable certificate that is bound to IP telephony device 102, for example via the MAC address of IP telephony device 102. This makes it more difficult for a third party to attempt to “spoof” 1P telephony device 102 using a different IP telephony device.

V. Implementation Mechanisms

The approach described herein for securely deploying IP telephony devices provides an automatic approach that is user friendly because a user does not need to be aware of any details of configuring an IP telephony device, such as particular configuration parameters or policies. The approach also reduces the amount of human resources required to configure new IP telephony devices at a configuration manager and is therefore well suited for large scale deployments. Furthermore, the approach may be used to remotely deploy IP telephony devices at any location.

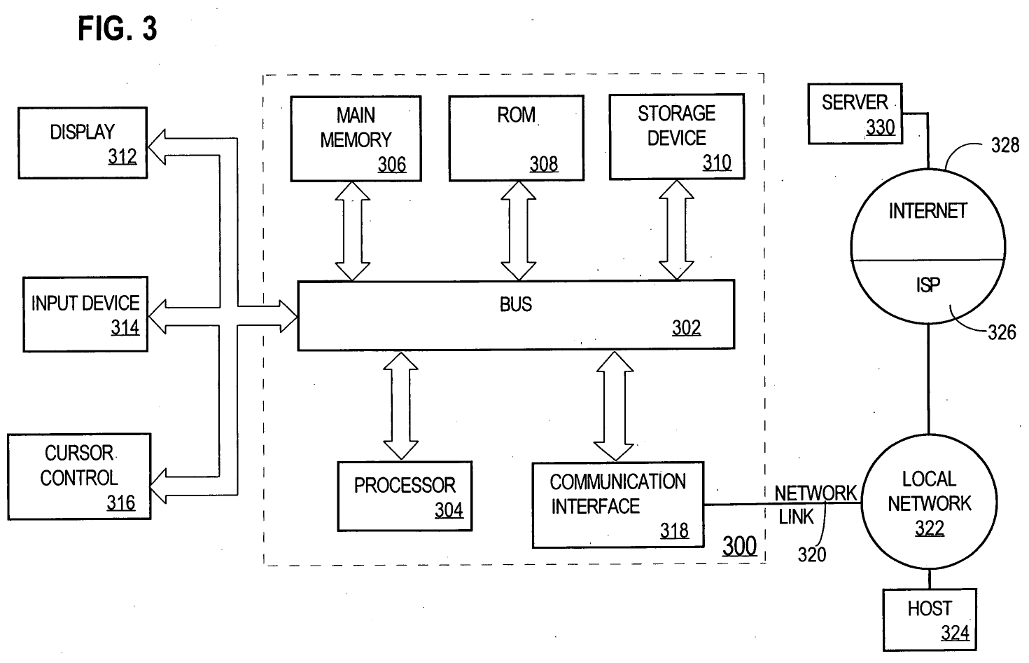

The approach described herein may be implemented in hardware, computer software or any combination of hardware and computer software on any type of computing platform. FIG. 3 is a block diagram that illustrates an example computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infrared data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infrared transmitter to convert the data to an infrared signal. An infrared detector can receive the data carried in the infrared signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318. The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for deploying an IP telephony device, the computer-implemented method comprising:
receiving, from a router over a secure communications link, a request to configure the IP telephony device connected to the router, wherein the request includes an IP address of the IP telephony device and data that uniquely identifies the IP telephony device;
in response to receiving the request, determining, based upon the data that uniquely identifies the IP telephony device, whether IP telephony service has been approved for the IP telephony device; and
if IP telephony service has been approved for the IP telephony device, then causing configuration data to be sent to the IP telephony device over the secure communications link.

2. The computer-implemented method as recited in claim 1, wherein the request is a connection event caused by a network services agent executing on the router and the computer-implemented method further comprises a network services engine processing the connection event.

3. The computer-implemented method as recited in claim 1, wherein determining, based upon the data that uniquely identifies the IP telephony device, whether IP telephony service has been approved for the IP telephony device includes determining whether a directory number has been assigned to the IP telephony device.

4. The computer-implemented method as recited in claim 1, further comprising binding a non-exportable digital certificate to the IP telephony device based upon the data that uniquely identifies the IP telephony device.

5. The computer-implemented method as recited in claim 1, further comprising securely maintaining an association between an IP address of the IP telephony device and the data that uniquely identifies the IP telephony device.

6. The computer-implemented method as recited in claim 6, further comprising receiving a notification from the router that a change has been made to the association between the IP address of the IP telephony device and the data that uniquely identifies the IP telephony device.

7. The computer-implemented method as recited in claim 1, wherein the router is configured to examine IP traffic received from the IP telephony device, determine an IP address of the IP telephony device based upon the examined IP traffic received from the IP telephony device and determine the data that uniquely identifies the IP telephony address based upon the IP address of the IP telephony device.

8. The computer-implemented method as recited in claim 1, wherein the data that uniquely identifies the IP telephony device is a Media Access Control (MAC) address or a Data Link Control (DLC) address.

9. The computer-implemented method as recited in claim 1, further comprising in response to receiving the request, causing a configuration manager to generate the configuration data for the IP telephony device.

10. A computer-readable medium for deploying an IP telephony device, the computer-readable medium carrying instructions which, when executed by one or more processors, cause:
receiving, from a router over a secure communications link, a request to configure the IP telephony device connected to the router, wherein the request includes an IP address of the IP telephony device and data that uniquely identifies the IP telephony device;
in response to receiving the request, determining, based upon the data that uniquely identifies the IP telephony device, whether IP telephony service has been approved for the IP telephony device; and
if IP telephony service has been approved for the IP telephony device, then causing configuration data to be sent to the IP telephony device over the secure communications link.

11. The computer-readable medium as recited in claim 10, wherein the request is a connection event caused by a network services agent executing on the router and the computer-readable medium further comprises additional instructions which, when executed by the one or more processors, cause a network services engine to process the connection event.

12. The computer-readable medium as recited in claim 10, wherein determining, based upon the data that uniquely identifies the IP telephony device, whether IP telephony service has been approved for the IP telephony device includes determining whether a directory number has been assigned to the IP telephony device.

13. The computer-readable medium as recited in claim 10, further comprising additional instructions which, when executed by the one or more processors, cause binding a non-exportable digital certificate to the IP telephony device based upon the data that uniquely identifies the IP telephony device.

14. The computer-readable medium as recited in claim 10, further comprising additional instructions which, when executed by the one or more processors, cause securely maintaining an association between an IP address of the IP telephony device and the data that uniquely identifies the IP telephony device.

15. The computer-readable medium as recited in claim 14, further comprising additional instructions which, when executed by the one or more processors, cause receiving a notification from the router that a change has been made to the association between the IP address of the IP telephony device and the data that uniquely identifies the IP telephony device.

16. The computer-readable medium as recited in claim 10, wherein the router is configured to examine IP traffic received from the IP telephony device, determine an IP address of the IP telephony device based upon the examined IP traffic received from the IP telephony device and determine the data that uniquely identifies the IP telephony address based upon the IP address of the IP telephony device.

17. The computer-readable medium as recited in claim 10, wherein the data that uniquely identifies the IP telephony device is a Media Access Control (MAC) address or a Data Link Control (DLC) address.

18. The computer-readable medium as recited in claim 10, further comprising additional instructions which, when executed by the one or more processors, cause in response to receiving the request, causing a configuration manager to generate the configuration data for the IP telephony device.

19. An apparatus for deploying an IP telephony device, the apparatus comprising a memory storing instructions which, when executed by one or more processors, cause:
receiving, from a router over a secure communications link, a request to configure the IP telephony device connected to the router, wherein the request includes an IP address of the IP telephony device and data that uniquely identifies the IP telephony device;
in response to receiving the request, determining, based upon the data that uniquely identifies the IP telephony device, whether IP telephony service has been approved for the IP telephony device; and
if IP telephony service has been approved for the IP telephony device, then causing configuration data to be sent to the IP telephony device over the secure communications link.

20. The apparatus as recited in claim 19, wherein the request is a connection event caused by a network services agent executing on the router and the computer-readable medium further comprises additional instructions which, when executed by the one or more processors, cause a network services engine to process the connection event.

21. The apparatus as recited in claim 19, wherein determining, based upon the data that uniquely identifies the IP telephony device, whether IP telephony service has been approved for the IP telephony device includes determining whether a directory number has been assigned to the IP telephony device.

22. The apparatus as recited in claim 19, wherein the memory further comprises additional instructions which, when executed by the one or more processors, cause binding a non-exportable digital certificate to the IP telephony device based upon the data that uniquely identifies the IP telephony device.

23. The apparatus as recited in claim 19, wherein the memory further comprises additional instructions which, when executed by the one or more processors, cause securely maintaining an association between an IP address of the IP telephony device and the data that uniquely identifies the IP telephony device.

24. The apparatus as recited in claim 23, wherein the memory further comprises additional instructions which, when executed by the one or more processors, cause receiving a notification from the router that a change has been made to the association between the IP address of the IP telephony device and the data that uniquely identifies the IP telephony device.

25. The apparatus as recited in claim 19, wherein the router is configured to examine IP traffic received from the IP telephony device, determine an IP address of the IP telephony device based upon the examined IP traffic received from the IP telephony device and determine the data that uniquely identifies the IP telephony address based upon the IP address of the IP telephony device.

26. The apparatus as recited in claim 19, wherein the data that uniquely identifies the IP telephony device is a Media Access Control (MAC) address or a Data Link Control (DLC) address.

27. The apparatus as recited in claim 19, wherein the memory further comprises additional instructions which, when executed by the one or more processors, cause in response to receiving the request, causing a configuration manager to generate the configuration data for the IP telephony device.

28. An apparatus for deploying an IP telephony device, the apparatus comprising:
means for receiving, from a router over a secure communications link, a request to configure the IP telephony device connected to the router, wherein the request includes an IP address of the IP telephony device and data that uniquely identifies the IP telephony device;
means for in response to receiving the request, determining, based upon the data that uniquely identifies the IP telephony device, whether IP telephony service has been approved for the IP telephony device; and
means for if IP telephony service has been approved for the IP telephony device, then causing configuration data to be sent to the IP telephony device over the secure communications link.

29. The apparatus as recited in claim 28, wherein the request is a connection event caused by a network services agent executing on the router and the computer-readable medium further comprises additional instructions which, when executed by the one or more processors, cause a network services engine to process the connection event.

30. The apparatus as recited in claim 28, wherein determining, based upon the data that uniquely identifies the IP telephony device, whether IP telephony service has been approved for the IP telephony device includes determining whether a directory number has been assigned to the IP telephony device.

31. The apparatus as recited in claim 28, further comprising means for binding a non-exportable digital certificate to the IP telephony device based upon the data that uniquely identifies the IP telephony device.

32. The apparatus as recited in claim 28, further comprising means for securely maintaining an association between an IP address of the IP telephony device and the data that uniquely identifies the IP telephony device.

33. The apparatus as recited in claim 32, further comprising means for receiving a notification from the router that a change has been made to the association between the IP address of the IP telephony device and the data that uniquely identifies the IP telephony device.

34. The apparatus as recited in claim 28, wherein the router is configured to examine IP traffic received from the IP telephony device, determine an IP address of the IP telephony device based upon the examined IP traffic received from the IP telephony device and determine the data that uniquely identifies the IP telephony address based upon the IP address of the IP telephony device.

35. The apparatus as recited in claim 28, wherein the data that uniquely identifies the IP telephony device is a Media Access Control (MAC) address or a Data Link Control (DLC) address.

36. The apparatus as recited in claim 28, further comprising means for in response to receiving the request, causing a configuration manager to generate the configuration data for the IP telephony device.
